(19) United States
(12) Patent Application Publication
(10) Pub. No.: US 2026/0312618 A1
(43) Pub. Date: Oct. 8, 2026

(54) FREQUENCY HOPPING OF REFERENCE SIGNAL

(71) Applicant: Nokia Technologies Oy, Espoo (FI)

(72) Inventors: Hyun-Su CHA, Chicago, IL (US); Ryan KEATING, Chicago, IL (US); Tao TAO, Shanghai (CN)

(73) Assignee: Nokia Technologies Oy, Espoo (FI)

(21) Appl. No.: 19/482,913

(22) PCT Filed: May 10, 2023
(86) PCT No.: PCT/CN2023/093208

§ 371 Date: Nov. 10, 2025

(51) Int. Cl. H04B 1/7143; H04L 27/26

(52) U.S. Cl. CPC H04B 1/7143; H04L 27/2613; H04L 27/2614

(57) ABSTRACT

Example embodiments of the present disclosure relate to methods, devices, apparatuses and computer readable storage medium for frequency hopping of a reference signal. In a method, a first device receives, from a second device, at least one configuration for frequency hopping of a reference signal. The at least one configuration includes information on at least a first reference signal sequence. Then, based on a determination that a condition related to a PAPR at one or more frequency hops is unsatisfied by the first reference signal sequence, the first device transmits a message requesting for a second reference signal sequence.

### FIELDS

Various example embodiments of the present disclosure generally relate to the field of telecommunication and in particular, to methods, devices, apparatuses and computer readable storage medium for frequency hopping of a reference signal (RS).

### BACKGROUND

New Radio (NR) positioning in Release 18 (Rel-18) supports Reduced Capability (RedCap) UE positioning. For high accuracy of the RedCap UE positioning, frequency hopping beyond the maximum RedCap UE bandwidth is introduced for reception of a downlink (DL) positioning reference signal (PRS) and transmission of an uplink (UL) sounding reference signal (SRS) for positioning. For SRS frequency hopping, a configuration is that each SRS frequency hop corresponds to a Zadoff-Chu (ZC) sequence. Thus, if four SRS frequency hops are assumed, a receiver may receive four different ZC sequences, in case the receiver performs coherent combining of the received SRSs over the four frequency hops to measure a timing measurement from wideband SRSs. Another configuration is using a single long ZC sequence for the SRS frequency hops, and each SRS frequency hop may comprise a part of a ZC sequence, which may cause a peak to average power ratio (PAPR) issue.

### SUMMARY

In a first aspect of the present disclosure, there is provided a method at a first device. In the method, the first device receives, from a second device, at least one configuration for frequency hopping of a reference signal. The at least one configuration includes information on at least a first reference signal sequence. Then, based on a determination that a condition related to a PAPR at one or more frequency hops is unsatisfied by the first reference signal sequence, the first device transmits a message requesting for a second reference signal sequence.

In a second aspect of the present disclosure, there is provided a method at a second device. In the method, the second device transmits, to a first device, at least one configuration for frequency hopping of a reference signal. The at least one configuration includes information on at least a first reference signal sequence. Then, the second device receives, from the first device, a message requesting for a second reference signal sequence.

In a third aspect of the present disclosure, there is provided a method at a third device. In the method, the third device receives, from a second device, at least one configuration for frequency hopping of a reference signal to be transmitted by a first device, the at least one configuration including information on at least a first reference signal sequence. The third device receives, from the first device, a message requesting for a second reference signal sequence.

In a fourth aspect of the present disclosure, there is provided a first device. The first device comprises at least one processor; and at least one memory storing instructions that, when executed by the at least one processor, cause the first device at least to: receive, from a second device, at least one configuration for frequency hopping of a reference signal, the at least one configuration including information on at least a first reference signal sequence; and based on a determination that a condition related to a PAPR at one or more frequency hops is unsatisfied by the first reference signal sequence, transmit a message requesting for a second reference signal sequence.

In a fifth aspect of the present disclosure, there is provided a second device. The second device comprises at least one processor; and at least one memory storing instructions that, when executed by the at least one processor, cause the second device at least to: transmit, to a first device, at least one configuration for frequency hopping of a reference signal, the at least one configuration including information on at least a first reference signal sequence; and receive, from the first device, a message requesting for a second reference signal sequence.

In a sixth aspect of the present disclosure, there is provided a third device. The second device comprises at least one processor; and at least one memory storing instructions that, when executed by the at least one processor, cause the third device at least to: receive, from a second device, at least one configuration for frequency hopping of a reference signal to be transmitted by a first device, the at least one configuration including information on at least a first reference signal sequence; and receive, from the first device, a message requesting for a second reference signal sequence.

In a seventh aspect of the present disclosure, there is provided a first apparatus. The first apparatus comprises means for receiving, from a second device, at least one configuration for frequency hopping of a reference signal, the at least one configuration including information on at least a first reference signal sequence; and means for based on a determination that a condition related to a peak to average power ratio (PAPR) at one or more frequency hops is unsatisfied by the first reference signal sequence, transmitting a message requesting for a second reference signal sequence.

In an eighth aspect of the present disclosure, there is provided a second apparatus. The second apparatus comprises means for transmitting, to a first device, at least one configuration for frequency hopping of a reference signal, the at least one configuration including information on at least a first reference signal sequence; and means for receiving, from the first device, a message requesting for a second reference signal sequence.

In a ninth aspect of the present disclosure, there is provided a third apparatus. The third apparatus comprises means for receiving, from a second device, at least one configuration for frequency hopping of a reference signal to be transmitted by a first device, the at least one configuration including information on at least a first reference signal sequence; and means for receiving, from the first device, a message requesting for a second reference signal sequence.

In a tenth aspect of the present disclosure, there is provided a computer readable medium. The computer readable medium comprises instructions stored thereon for causing an apparatus to perform at least the method according to the first or second aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1A illustrates an example communication environment in which example embodiments of the present disclosure can be implemented;

FIG. 1B illustrates an example frequency hopping process;

FIG. 1C illustrates an example of configurations for SRS frequency hopping within an SRS resource;

FIG. 2 illustrates a signaling diagram for an example communication process in the communication environment according to some example embodiments of the present disclosure;

FIG. 3 illustrates an example process of RS frequency hopping in accordance with some example embodiments of the present disclosure;

FIG. 4 illustrates another example process of RS frequency hopping in accordance with some other example embodiments of the present disclosure;

FIG. 5 illustrates a further example process of RS frequency hopping in accordance with yet some other example embodiments of the present disclosure;

FIG. 6 illustrates a flowchart of a method implemented at a first device according to some example embodiments of the present disclosure;

FIG. 7 illustrates a flowchart of a method implemented at a second device according to some example embodiments of the present disclosure;

FIG. 8 illustrates a flowchart of a method implemented at a third device according to some example embodiments of the present disclosure;

FIG. 9 illustrates a simplified block diagram of a device that is suitable for implementing example embodiments of the present disclosure; and

FIG. 10 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second” and the like may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

As mentioned above, Rel-18 NR positioning supports RedCap UE positioning. For example, frequency hopping beyond the maximum RedCap UE bandwidth may be supported for reception of a DL PRS and transmission of a UL SRS for positioning. Moreover, radio resource management (RRM) requirements for positioning may be needed, which includes RRM measurements and procedures for RedCap UEs for both with and without frequency hopping. The complexity of the corresponding capabilities for RedCap UEs needs to be addressed for the introduction of appropriate capabilities for RedCap UEs.

For RedCap UEs, at least measurements on DL PRS with receiving (Rx) frequency hopping using a measurement gap are supported. The following is for further study: details on RedCap UE processing capabilities for DL PRS with Rx frequency hopping and a measurement gap (MG), the use of single or multiple instances of MGs, and the use of PRS processing window (PPW). The scope for RedCap positioning includes frequency range 1 (FR1) and frequency range 2 (FR2).

For positioning enhancements for RedCap UEs for UL SRS transmitting (Tx) and DL PRS Rx frequency hopping, a short switching time to allow radio frequency (RF) retuning between adjacent hops may be beneficial in terms of accuracy and latency performance. A location service (LS) may be sent to a radio access network (RAN) to request feedback on the feasible values for the switching time between hops, for example, when numerology and bandwidth for each hop can be the same, and the Tx and Rx antennas used in all hops can be the same.

For positioning for RedCap UEs with DL PRS Rx hopping, the UE may hop within a DL PRS resource. SRS positioning frequency hopping may be supported by using a configuration separate from the existing bandwidth part (BWP) configuration. Hopping may be configured within an SRS resource or across SRS resources.

Based on the above, configurations need to be introduced to support SRS for positioning (SRS-Pos) frequency hopping, which is separate from the current UL BWP framework. Thus, the SRS frequency hopping may not be configured within the BWP configuration. However, in NR, the transmission of UL SRSs (including other RSs) for radio resource control (RRC) connected (RRC_CONNECTED) UEs is tied with the UL BWP configuration.

If the current NR SRS configuration for SRS frequency hopping is followed, each SRS frequency hop comprises a Zadoff-Chu (ZC) sequence. If four SRS frequency hops are assumed, the receiver or the gNB may receive four different ZC sequences. A proposed SRS configuration approach uses a single long ZC sequence with SRS frequency hopping so that a receiver can see a single sequence. In principle, the ZC sequence exhibits good cross-correlation property as it is an orthogonal sequence, and it inherently possesses a low PAPR property as the ZC sequence is constant envelop signals, which obviates a high PAPR issue for the transmission of the SRS. However, the low PAPR property of the ZC sequence may not be preserved when transmitting only a part of the ZC sequence.

Example embodiments of the present disclosure propose a scheme to reduce a PAPR during a transmission of reference signal (RS) frequency hops. With this scheme, if a condition related to a PAPR at one or more of the frequency hops configured for a RS is unsatisfied by the currently configured RS sequence, a device such as a UE requests a different RS sequence. The device may expect to be configured with a further RS sequence satisfying a PAPR related condition for one or more RS frequency hops.

In this way, low PAPR performance may be provided for SRS frequency hopping operation. Moreover, signal distortion due to high PAPR may be avoided, thereby improving transmission accuracy, measurement accuracy at the receiver, and efficiency.

It is to be understood that although the issue is originating from the RS for the positioning purposes, the proposed solution in this disclosure can be applied in general for various RSs that may be suffered signal distortion due to PAPRs.

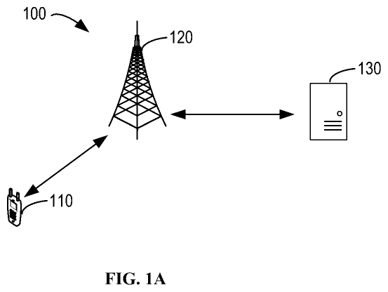

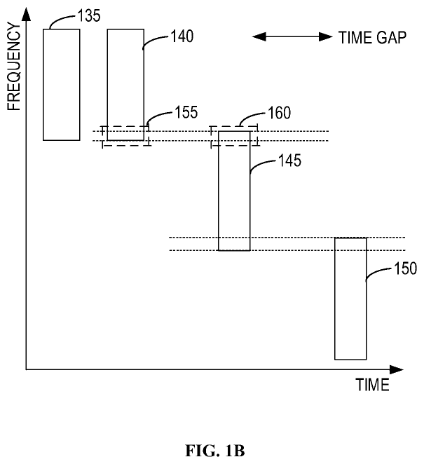

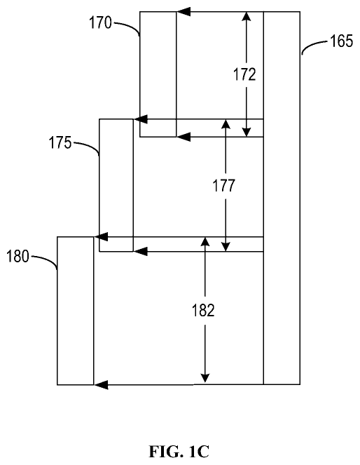

FIG. 1A illustrates an example communication environment 100 in which example embodiments of the present disclosure can be implemented. In the communication environment 100, a first device 110 and a second device 120 can communicate with each other. In some example embodiments, the first device 110 may be a terminal device which may be a RedCap UE. The second device 120 may be a network device such as a gNB.

In the following, for the purpose of illustration, some example embodiments are described with the first device 110 operating as a terminal device and the second device 120 operating as a network device. However, in some example embodiments, operations described in connection with a terminal device may be implemented at a network device or other device, and operations described in connection with a network device may be implemented at a terminal device or another device.

In some example embodiments, if the first device 110 is a terminal device and the second device 120 is a network device, a link from the second device 120 to the first device 110 is referred to as a downlink (DL), while a link from the first device 110 to the second device 120 is referred to as an uplink (UL). In DL, the second device 120 is a transmitting (TX) device (or a transmitter) and the first device 110 is a receiving (RX) device (or a receiver). In UL, the first device 110 is a TX device (or a transmitter) and the second device 120 is a RX device (or a receiver). If both the first device 110 and the second device 120 are terminal devices, a link between two terminal devices is referred to as a sidelink (SL). In SL, one of the first and second devices 110 and 120 is a TX device (or a transmitter), and the other of the first and second devices 110 and 120 is a RX device (or a receiver).

The environment 100 further includes a third device 130 which may operate a location device such as an LMF that provides positioning-related services to the first device 110. The third device 120 can communicate with the first and second devices 110 and 120. In some example embodiments, the third device 130 may communicate with the first device 110 using an LTE positioning protocol (LPP). The communication between the first device 110 and the third device 120 may be forwarded by the second device 120 or transparent to the second device 120.

It is to be understood that the third device 130 is shown to be physically separate from the second device 120 only for the purpose of illustration, without suggesting any limitation. The third device 130 may be implemented by a physical or virtual device. The third device 130 may be implemented as a hardware, firmware, and/or algorithm-based software component within any of the network nodes (such as the terminal device, the base station, and/or the like). In some example embodiments, the third device 130 may be physically integrated into or implemented as a part of the second device 120. In some example embodiments, the third device 130 may be at least partially implemented as a network function of a core network, and/or the like.

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

In various example embodiments, the frequency hopping operation is applied in RS transmissions, for example, for the positioning purposes. The RS may comprise a DL PRS, a sidelink PRS, or an UL SRS. It is to be understood that the number of devices and their connections shown in FIG. 1A are only for the purpose of illustration without suggesting any limitation. The communication environment 100 may include any suitable number of devices configured to implement example embodiments of the present disclosure. Although not shown, it would be appreciated that one or more additional devices may be deployed in the communication environment 100 which can receive the RS from the first device 110, for example, for the positioning purposes.

In some example embodiments, a virtual resource configuration may be used for the RS. For example, a virtual BWP may be configured with a large physical BWP which may exceed the maximum bandwidth allowed by the capability of the first device 110 such as a RedCap UE. The virtual RS configuration is to configure RS resources over a large bandwidth beyond the UE capability on the maximum bandwidth or bandwidth part size.

An example of the expected RS frequency hopping operation will be described below with reference to FIG. 1B. In this example, the RS is an SRS. The SRS may be an SRS configured for MIMO (Multiple Input Multiple Output) operation such as channel state information acquisition, antenna switching, and beam management. In another example, the SRS may an SRS configured for positioning purpose.

FIG. 1B illustrates an example frequency hopping process. There is an active UL BWP 135 for the first device 110, and three SRS frequency hops including a SRS frequency hop 140, a SRS frequency hop 145, and a SRS frequency hop 150 are assumed. The SRS frequency hop 140 is transmitted within the UL active BWP 135, while other two SRS frequency hops 145 and 150 are transmitted outside of the active BWP 135.

Two different SRS frequency hops have overlapped resource block(s) so that the receiver can measure a phase offset or phase discontinuity, where the phase discontinuity is generated as the first device may not be able to keep a constant phase for the SRS transmission over multiple frequency hops. For example, resource blocks 155 of the SRS frequency hop 140 overlap with resource blocks 160 of the SRS frequency hop 145. Similarly, the SRS frequency hop 145 and the SRS frequency hop 150 are also overlapped.

After a transmission of an SRS frequency hop, the first device 110 needs a gap time to perform an RF switching. The compensation for the phase difference is needed for the second device 120 to perform a coherent combining over the three SRS frequency hops. As a consequence, the receiver such as the second device 120 can obtain positioning measurements from a wide-band SRS by stitching the frequency hops and the coherent combining to obtain a positioning measurement, thereby providing high-accuracy of positioning for the RedCap UEs.

In some example embodiments, the first device 110 may use a single long ZC sequence for the RS frequency hopping. An example of such a RS configuration will be described below with reference to FIG. 1C where an SRS is transmitted.

FIG. 1C illustrates an example of configurations for SRS frequency hopping within an SRS resource. This example of configurations for SRS frequency hopping may include at least information on the locations of SRS frequency hops and an SRS resource 165 with a generated long ZC sequence. In this example, SRS frequency hops include a SRS frequency hop 170, a SRS frequency hop 175, and a SRS frequency hop 180. The SRS resource 165 with a generated long ZC sequence may be allocated to the SRS frequency hops, and a part of ZC sequence may be allocated to its corresponding SRS frequency hop. For example, a first part of ZC sequence 172 may be allocated to the SRS frequency hop 170, a second part of ZC sequence 177 may be allocated to the SRS frequency hop 177, and a third part of ZC sequence 182 may be allocated to the SRS frequency hop 180. As a result, the first device 110 transmits a part of the ZC sequence when the first device 110 transmits each SRS frequency hop. To reduce PAPRs, if a RS sequence (referred to as a first RS sequence) cannot satisfied a PAPR related condition, the first device 110 can request another RS sequence (referred to as a second RS sequence) than can satisfy the condition.

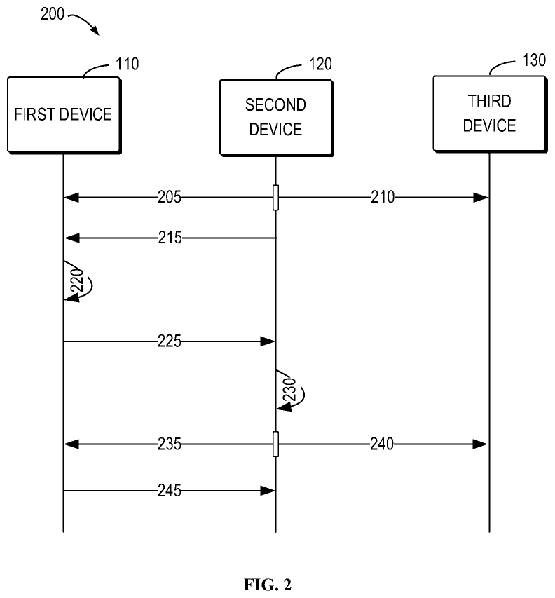

Some example implementations will be described in detail below with reference to FIGS. 2 to 5.

FIG. 2 illustrates a signaling diagram for an example communication process 200 among the first device 110, the second device 120, and the third device 130 in the communication scenario 100 according to some example embodiments of the present disclosure.

As shown in FIG. 2, the second device 120 may transmit (205) at least one configuration for frequency hopping of a reference signal to the first device 110. Accordingly, the first device 110 may receive the at least one configuration for frequency hopping of the reference signal from the second device 120. For example, the reference signal may be an SRS for positioning. The at least one configuration may include information on at least a first reference signal sequence. In some cases, the first reference signal sequence may serve as a first SRS sequence provided by the second device 120 for the first device 110 to use for SRS frequency hopping.

In some example embodiments, the at least one configuration that the second device 120 provides to the first device 110 may comprise a configuration that at least contains information on the number of SRS frequency hops, identities of frequency hops, the time-domain and frequency-domain resource(s) of each SRS frequency hop, sequence mapping from a virtual SRS resource to each SRS frequency hop. As such, the first device 110 may perform the SRS frequency hopping based on the configuration.

In some example embodiments, as shown in FIG. 2, the second device 120 may also transmit (210) to the third device 130 the at least one configuration for the frequency hopping of the reference signal to be transmitted by the first device 110. Accordingly, the third device 130 may receive from the second device 120 the at least one configuration for frequency hopping of a reference signal to be transmitted by the first device 110. In some example embodiments, the third device 130 may provide other network devices such as neighbor network device(s) with the at least one configuration for the frequency hopping provided by the second device 120. Other network devices may provide a neighbor cell of the serving cell provided by the second device 120.

In some example embodiments, the second device 120 may transmit (215) at least one allowable signal distortion level (also referred to as a tolerant signal distortion level) of at least one receiver of the reference signal to the first device 110, and then the first device 110 may receive the at least one allowable signal distortion level. The tolerant signal distortion level may indicate the information on the tolerant or acceptable level of the signal distortion. In some example embodiments, the second device 120 may provide the first device 110 via RRC signaling with the tolerant signal distortion level on SRS transmission over frequency hops. For example, this tolerant signal distortion level may be included in a part of the RRC configuration signaling for SRS frequency hopping.

In some example embodiments, the at least one tolerant signal distortion level may comprise a plurality of tolerant signal distortion levels of a plurality of receivers of the RS. The tolerant signal distortion level of the multiple tolerant signal distortion levels may be indicated per receiver. In some cases, the tolerant signal distortion level and the at least one configuration for the frequency hopping may be transmitted from the second device 120 to the first device 110 in one signaling message.

In some example embodiments, the tolerant signal distortion level may be determined by the second device 120 based on a received signal strength of the at least one receiver, approximated distance between the first device 110 and the at least one receiver, and/or required measurement accuracy of the at least one receiver. The receiver may be a transmission reception point (TRP) or a gNB. In some cases, if a TRP may perform measurements in a relatively accurate way as the first device 110 is closer to the TRP, the TRP may be somewhat tolerant to the signal distortion.

In another example embodiment, different receivers may allow different tolerant signal distortion levels. In this case, the second device 120 may provide the first device 110 with a tolerant level of signal distortion per gNB or per TRP.

In some scenarios, the tolerant signal distortion level may be transmitted by the third device 130 to the first device 110. For example, the third device 130 may collect the information on different receivers (such as neighbor gNBs and TRPs) of the RS. Based on such information as the received signal strength, approximated distance between the first device 110 and receivers, required accuracy, and so forth, the third device 130 may determine tolerant signal distortion levels of the receivers.

After the first device 110 receives from the second device 120 the at least one configuration for the frequency hopping of the reference signal, the first device 110 may determine (220) whether a condition related to a PAPR is satisfied by the first reference signal sequence. In some example embodiments, the satisfaction of the conditional may be determined by comparing a PAPR associated with the first RS sequence with a threshold PARP. For example, the first device 110 may determine whether the PAPR associated with the first reference signal sequence is greater than a threshold PAPR at one or more frequency hops.

The number of frequency hops for condition determination may be defined depending on actual needs or network deployment. In some example embodiments, the condition may be determined to be unsatisfied if the PAPRs at all the frequency hops is greater than the threshold PAPR. In some other example embodiments, the condition may be unsatisfied in the PAPRs at a predetermined number of frequency hops is greater. In an example, the predetermined number may be one. In other words, only if the PAPRs at all the frequency hops is equal to or smaller than the threshold PAPR, the condition is determined to be satisfied.

In some example embodiments, one or more threshold PAPRs may be used. At least one threshold PAPR (the threshold value of the threshold PAPR may be referred to as no) may be determined by the first device 110 based on at least one of: a power amplifier capability of the first device 110 or at least one allowable signal distortion level of at least one receiver of the reference signal. The power amplifier capability may include a dynamic range of the first device 110. For example, the first device 110 may be equipped with a power amplifier that has 3 dB dynamic range. In this example, if the PAPR of the transmission signal exceeds 3 dB, the transmission signal is distorted by nonlinearity of the power amplifier. Thus, no may be determined to be 3 dB.

In some example embodiments, different devices may have different power amplifiers with different performance of dynamic range. Based on the information on the tolerant signal distortion level provided by the second device 120 or the third device 130, the threshold value no may be different depending on different devices such as different UEs. For example, the threshold value no used by the first device 110 may be different from the threshold value used by another device which has a different power amplifier capability.

In some example embodiments, if the first device 110 is provided with the same tolerant level of signal distortion across all target cells or gNBs, the first device 110 determines a threshold value (η₀) of the threshold PAPR (or “a threshold value of PAPR”) based on its power amplifier capability and the provided tolerant level of the signal distortion. In some example embodiments, if the first device 110 is provided with a different tolerant level of signal distortion for each target cell or gNB, the first device 110 may determine a threshold value (η_{0,l,}) of PAPR for each 1-th TRP or 7-th cell where l∈{1, 2, . . . , K}, based on its power amplifier capability and the provided tolerant level of the signal distortion. The first device 110 may take into account a provided TRP ID or cell ID included in the spatial relation information and/or pathloss reference information associated with an SRS resource as a target TRP or cell for the transmission of the SRS resource. In this way, the first device 110 may determine the same or different PAPR threshold value for the transmission of each RS resource depending on the target TRP or cell.

By way of example, based on the configuration for the frequency hopping of the RS provided by the second device 120, the first device 110 may calculate a PAPR (or a PAPR value) of each RS frequency hop. In some examples, the first device 110 may calculate a cubic metric for PARP values of the frequency hops. As an example, the first device 110 may derive the PAPR of each RS frequency hop for the provided RS sequence.

For example, the first device 110 may calculate the PAPR of the j-th RS frequency hop as follows:

$${PAPR}_{j} = \frac{{‖ {Q}_{IDFT} ( {x}_{j} ) ‖}_{∞}}{\frac{1}{{N}_{j}} \times [ {‖ {Q}_{IDFT} ( {x}_{j} ) ‖}^{2} ]} , where j ∈ \{ 1 , 2 , … , M \} \qquad ( 1 )$$

xⱼ∈Nⱼ×1 is a vector representing the sequence to be transmitted through the j-th RS frequency hop, where x=[x₁, x₂, . . . , x_{M}]. Q_{IDFT} represents an inverse discrete Fourier transform matrix. M represents the total number of configured RS frequency hops. Nⱼ represents the number of subcarriers of j-th RS frequency hop. That is, equation (1) means a ratio of the maximum power of the time-domain Tx signals at the j-th frequency hop and the average power of this Tx signals. If the ratio is high, the device may need a power amplifier providing a large dynamic range to avoid non-linear signal distortion, where the dynamic range means a linear operating range of the power amplifier.

In some example embodiments, based on the calculated PAPR values and an indicated allowable level of signal distortion for one or more RS frequency hops, the first device 110 may decide whether to use the provided RS sequence for the transmission of RS frequency hops or not. For example, the first device 110 may determine not to use the provided sequence if the PAPR value of any one of the frequency hops is greater than the threshold PAPR, for example, PAPRⱼ>η₀ for all j∈{1, 2, . . . , M}. As another example, the first device 110 may determine not to use the provided sequence if PAPR values of a part of frequency hops are greater than the threshold, for example, PAPRⱼ>η₀ for M₁ frequency hops (wherein M₁>1). In some example embodiments, the M₁ value may be indicated by the second device to the first device. The first device may be configured to not use the provided sequence if PAPR values of M₁ frequency hops are greater than the threshold PAPR.

By way of example, for all of the RS frequency hops, the first device 110 may take into account the signal distortion that may occur due to the high PAPR, and it may try to keep the PAPR below a specific threshold or level (e.g., no) to maintain the quality of transmitted signals. For example, the first device 110 may use the following criterion. If PAPRⱼ>η₀ for all j∈{1, 2, . . . , M}, the first device 110 may determine that it will not use this RS sequence.

As an alternative example, if PAPRⱼ>η₀ for a part of SRS frequency hops (M₁ where M₁<M), the first device 110 may determine that it will not use this RS sequence. In this example, the signal distortion is allowed in a part of the RS frequency hops, which is more feasible and flexible as it may be difficult to maintain PAPR values for overall RS frequency hops below a threshold.

In another example, in the example embodiments where the second device 120 may provide the first device 110 with different tolerant signal distortion levels per receiver, the first device 110 may use the different threshold values for different receivers as follows: if PAPRⱼ>η_{0,l} for all j∈{1, 2, . . . , M} and for the 7-th TRP or cell, the first device 110 may determine that it will not use the RS sequence for the RS resource targeting the 1-th TRP or cell. If PAPRⱼ<η_{0,l} for M₁(<M) RS frequency hops and for the l-th TRP or cell, the first device 110 may determine that it will not use the RS sequence for the RS resource targeting the l-th TRP or cell.

In some example embodiments, the first device 110 may approximately derive the signal distortion level based on its power amplifier capability such as a dynamic range. For example, the first device 110 can assume that the time-domain transmission signal is distorted or clipped outside of the dynamic range. In this case, if the tolerant signal distortion level is not provided by the network, the first device 110 may determine the threshold PAPR based on the power amplifier capability.

If based on a comparison of a PARP associated with the first RS sequence and the threshold PAPR, the first device 110 determines that the condition is unsatisfied by the first RS sequence, as shown in FIG. 2, the first device 110 may transmit (225) to the second device 120 a message requesting for another RS sequence (referred to as a second RS sequence) which may need to satisfy the condition. In an example, the message may include a first request of a configuration for at least the second RS sequence. In some example embodiments, the requesting message may be transmitted via a configured-grant PUSCH. In the case that the first device 110 operates as an RRC_INACTIVE UE, the Message 3 or Message A may be used for the transmission of the message. Alternatively, or in addition, a new RRC signaling may be used.

After receiving the message from the first device 110, the second device 120 may determine (230) the second RS sequence for the first device 110. In some example embodiments, after the first device 110 determines the threshold PAPR no, the first device 110 may transmit the threshold PAPR to the second device 120. In an example, the threshold PAPR may be included in the message requesting for the second RS sequence that is transmitted from the first device 110 to the second device 120. In some example embodiments, based on the threshold PAPR received from the first device 110, the second RS sequence may be determined by the second device 120 as it satisfies the following condition: PAPRⱼ<η₀ for all j∈{1, 2, . . . , M}, or PAPRⱼ<η₀ for M₁ (M₁<M) RS frequency hops.

For example, in the case that the first device 110 may determine the same or different PAPR threshold value for the transmission of each RS resource depending on the target TRP or cell, the first device 110 may transmit the requesting message to trigger the network to provide another RS sequence for the frequency hopping so that it satisfies at least one of the following condition: PAPRⱼ<η_{0,l} for all j∈{1, 2, . . . , M} and for the l-th TRP or cell, or PAPRⱼ<η_{0,l} for M₁ (<M) SRS frequency hops and for the l-th TRP or cell.

In some example embodiments, the second device 120 may check the currently allocated sequences to the devices (such as RedCap UEs) for RS frequency hopping and determine an SRS sequence satisfying the requested PAPR level. To determine the second RS sequence, the second device 120 may try an exhaustive search in the feasible set of RS sequences and may calculate PAPRs as described above, and the second device 120 may also use no to compare the calculated PAPR to the threshold value.

In some example embodiments, the message requesting for the second RS sequence transmitted from the first device 110 to the second device 120 may include a set of RS sequences that is recommended by the first device 110. The set of RS sequences may satisfy the required PAPR to transmit RS on the RS frequency hops. In some example embodiments, the first device 110 may determine the set of RS sequences based on the configuration for frequency hopping of the reference signal. Then, the second device 120 may take into account the set of sequences and check already allocated sequences to other devices. If there is no interference issue, the second device 120 may provide the second RS sequence by selecting one sequence in the set RS sequences provided by the first device 110.

In some example embodiments, the determination of the second RS sequency may be implemented by the third device 130. For example, the first device 110 may transmit the requesting message requesting to the third device 130. Then, the third device 130 may determine a set of RS sequences. For example, the third device 130 may try an exhaustive search in the feasible set of RS sequences and find the RS sequences that can satisfy the condition. In some example embodiments, the first device 110 may send a set of recommended RS sequences to the third device 130. In this case, the third device 130 may determine a further set of RS sequences from the set of RS sequences provided by the first device 110.

Then, the third device 130 may transmit the further set of RS sequences to the second device 120. After the second device 120 receives the further set of reference signal sequences from the third device 130, the second reference signal sequence to be used by the first device 110 may be determined by the second device 120 from the further set of reference signal sequences provided by the third device 130.

As shown in FIG. 2, after the second device 120 determines (230) the second RS sequence, the second device 120 may transmit (235) a configuration for the second RS sequence to the first device 110. In some example embodiments, the second device 120 may provide the first device 110 with an identification (ID) of the second RS sequence that satisfies the requested PAPR condition. In this case, the first device 110 may use the second RS sequence for the SRS frequency hopping and transmit (245) a RS generated based on the second RS sequence. The surrounding devices may receive the RS from the first device 110, for example, for positioning of the first device 110.

In some example embodiments, as shown in FIG. 2, the second device 120 may also transmit (240) such a configuration to the third device 130. Then, the third device 130 may inform the second RS sequence to other devices such as neighbor gNBs or cells. In some scenarios, the neighbor cells are provided with the updated sequence for the RS resource for frequency hopping by the third device 130. Accordingly, the RS transmitted by the first device 110 may also be received by the neighbor devices.

In some example embodiments, the second device 120 may not accept the first request for at least the second RS sequence from the first device 110. For example, the second device 120 may not accept the first request if all of the feasible sequences were already allocated to other devices. In this case, the second device 120 may send a notification of a rejection for the second reference signal sequence to the first device 110, which may mean that the first request is rejected. Then the first device 110 may receive such a notification. In this case, the first device 110 may use the currently configured first RS sequence to generate a RS.

By way of example, the first device 110 may transmit RS over RS frequency hops. In this case, if the first device 110 receives the updated second RS sequence, the first device 110 may transmit the RS over RS frequency hops using the updated RS sequence. If the first request for the second RS sequence is not accepted by the second device 120, then the first device 110 may transmit the RS over RS frequency hops using the currently configured first RS sequence.

In some example embodiments, the first device 110 may report to the second device 120 which RS frequency hop(s) is affected by high PAPR problem. In an example, if a PAPR associated with the first reference signal sequence is greater than a threshold at certain frequency hop(s), the first device 110 may determine that the frequency hop(s) is affected from signal distortion associated with a PAPR or affected by high PAPR problem. The first device 110 may transmit to the second device 120 information on at least one affected frequency hop such as IDs of the frequency hop (or frequency hop IDs).

In some example embodiments, the second device 120 may transmit to the first device 110 an indication to report an affected frequency hop. Based on this indication, the first device 110 may inform the second device 120 which RS frequency hops are affected by the PAPR problem.

Alternatively, or in addition, the first device 110 may instead calculate a necessary bandwidth of each hop for a given sequence in order to avoid the high PAPR issue and then inform the second device 120 about this requirement. For example, in the case that the first device 110 is configured with a bandwidth of 20 MHz for each frequency hop, the first device 110 may determine that for the configured RS sequence, if it uses hops of 10 MHz, then it may avoid the high PAPR issue. Similarly, the first device 110 may determine that a larger hop bandwidth (still less than or equal to 20 MHz) may avoid the higher PAPR issue.

In some example embodiments, if the condition related to PAPR is not satisfied by the first SRS sequence, the first device 110 may transmit a second request to the second device 120. The second request may comprise at least one of: a bandwidth or the number of resource block(s) of at least one frequency hop, or the number of overlapping resource block(s), such as physical resource blocks (PRBs), between frequency hops. The first device 110 then requests the second device 120 to reconfigure it with the new bandwidth per hop in order to use the same RS sequence originally configured by the second device 120. Similarly, the first device 110 may request a different amount of overlapping PRBs between the hops such that the PAPR issue is resolved. In this case, the bandwidth size may be reduced by reducing the overlapping PRBs.

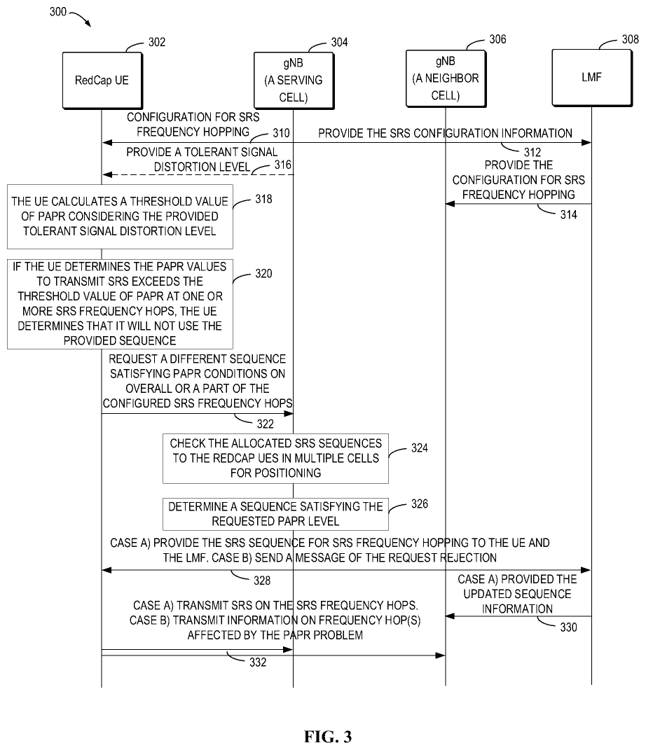

Some example processes of RS frequency hopping will be described below with reference to FIGS. 3 to 5. In these processes, a RedCap UE 302 is an example implementation of the first device 110, which may transmit an SRS for positioning. A gNB 304 which serves a serving cell is an example implementation of the second device 120. There is also a gNB 306 which serves a neighbor cell. In addition, an LMF 308 is an example implementation of the third device 130. The LMF 308 may initiate a positioning session for the RedCap UE 302. The LMF 308 may trigger a UL-based positioning approach or Multi-Round Trip Time (Multi-RTT) approach.

Reference is first made to FIG. 3 which illustrates an example process 300 of RS frequency hopping in accordance with some example embodiments of the present disclosure.

In the process 300, at 310, the gNB 304 may transmit a configuration for SRS frequency hopping to the RedCap UE 302. At 312, the gNB 304 may also transmit the configuration for SRS frequency hopping to the LMF 308. At 314, the LMF 308 may provide the configuration for SRS frequency hopping to the gNB 306.

At 316, the gNB 304 may provide a tolerant signal distortion level to the RedCap UE 302. Then, at 318, the RedCap UE 302 may calculate a threshold value of PAPR considering the provided tolerant signal distortion level. At 320, if the RedCap UE 302 determines that the PAPR values to transmit an SRS exceeds the calculated threshold value of PAPR at one or more SRS frequency hops, the RedCap UE 302 determines that it will not use the provided sequence. Then, at 322, the RedCap UE 302 may request the gNB 304 for a different sequence satisfying PAPR conditions on overall or a part of the configured SRS frequency hops, so that the gNB 304 may provide another SRS sequence to be used for SRS transmission on the SRS frequency hops.

At 324, the gNB 304 may check the currently allocated SRS sequences to the RedCap UEs in multiple cells for positioning. At 326, the gNB 304 may determine a sequence satisfying the requested PAPR level. To determine the sequence, the gNB 304 may try an exhaustive search in the feasible set of SRS sequences.

At 328, in case A), the gNB 304 may provide the determined SRS sequence for SRS frequency hopping to the RedCap UE 302 and to the LMF 308. In this case, at 330, the LMF 308 may provide the updated sequence information to the gNB 306, and at 332 the RedCap UE 302 may transmit SRS on the SRS frequency hops to the gNB 304.

In case B), at 328, the gNB 304 may send a message to inform the RedCap UE 302 that the request is rejected. Then, at 332, the RedCap UE 302 may transmit information on frequency hop(s) affected by the PAPR problem to the gNB 304.

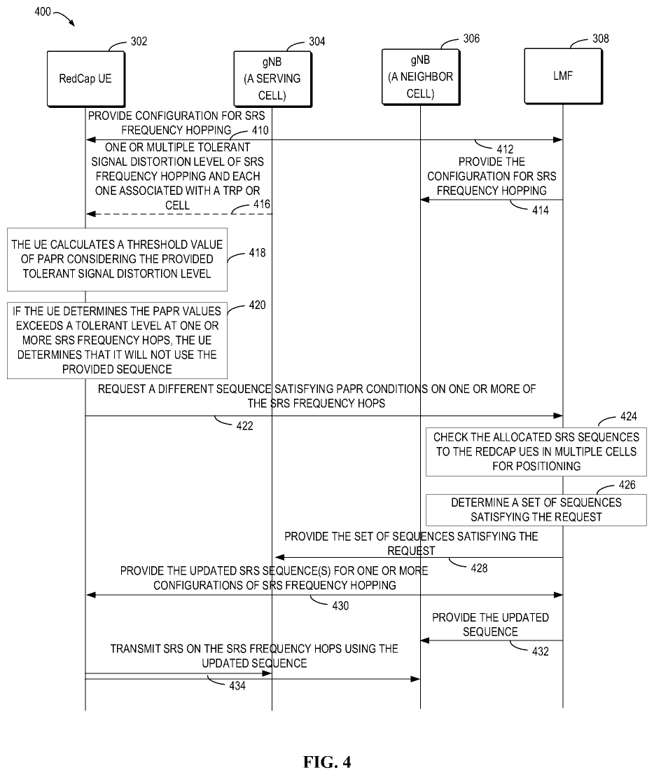

FIG. 4 illustrates another example process 400 of RS frequency hopping in accordance with some other example embodiments of the present disclosure.

Similar to the process 300 as shown in FIG. 3, in the process 400, at 410, the gNB 304 may transmit a configuration for SRS frequency hopping to the RedCap UE 302. At 412, the gNB 304 may also transmit the configuration for SRS frequency hopping to the LMF 308. At 414, the LMF 308 may provide the configuration for SRS frequency hopping to the gNB 306.

At 416, the gNB 304 may provide one or multiple tolerant signal distortion levels of SRS frequency hopping where each one is associated with a TRP or cell to the RedCap UE 302. At 418, the RedCap UE 302 may calculate a threshold value of PAPR considering the provided tolerant signal distortion level(s). At 420, if the RedCap UE 302 determines the PAPR values exceed a tolerant level at one or more SRS frequency hops, the RedCap UE 302 may determine that it will not use the provided sequence.

In this example, different from the process 300 as shown in FIG. 3, at 422, the RedCap UE 302 may request the LMF 308 (instead of the gNB 304) for a different sequence satisfying PAPR condition on one or more of the SRS frequency hops, so that the LMF 308 may provide another SRS sequence to be used for SRS transmission on the SRS frequency hops.

At 424, the LMF 308 may check the currently allocated SRS sequences to the RedCap UEs in multiple cells for positioning. At 426, the LMF 308 may determine a sequence satisfying the requested PAPR level. To determine the sequence, the LMF 308 may try an exhaustive search in the feasible set of SRS sequences.

Then, at 428, the LMF 308 may transmit to the gNB 304 the determined set of sequences satisfying the request of the RedCap UE 302. After the gNB 304 receives the determined set of sequences, at 430, the gNB 304 may transmit the updated SRS sequences for one or more configurations of SRS frequency hopping to the RedCap UE 302 and to LMF 308. Then, at 432, the LMF 308 provides the updated SRS sequences to the gNB 306. At 434, the RedCap UE 302 may transmit SRS on the SRS frequency hops using the updated SRS sequences to the gNB 304 and the gNB 306.

Thus, in this example, the LMF 308 may receive the request from the RedCap UE 302 and provide a set of sequences to the gNB 304 so that the gNB 304 may determine the sequence to be used by the RedCap UE 302. The gNB 304 may determine the sequence to be used and provide the determined sequence to the LMF 308, and then the LMF 308 may provide the sequence to the gNB 306 which serves neighbor cell(s).

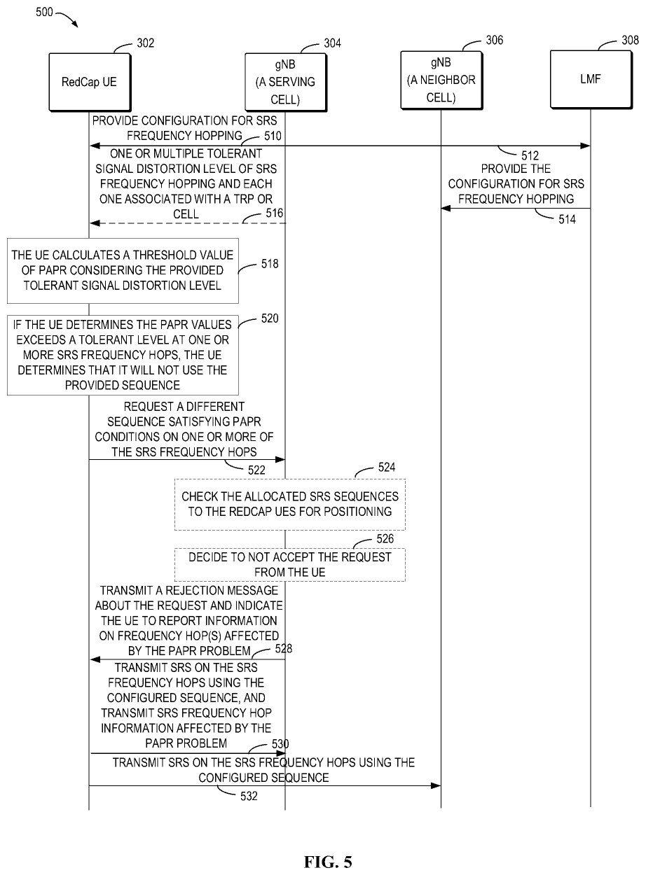

FIG. 5 illustrates a further example process 500 of RS frequency hopping in accordance with yet some other example embodiments of the present disclosure.

In the process 500, the operations at 510 to 520 are similar to the operations at 410 to 420 in the process 400 as shown in FIG. 4. For the purpose of simplification, the details will be omitted. Different from the process 400 in FIG. 4, but similar to the process 300 in FIG. 3, at 522, the RedCap UE 302 may request the gNB 304 for a different sequence satisfying PAPR conditions on one or more of the SRS frequency hops, so that the gNB 304 may provide another SRS sequence to be used for SRS transmission on the SRS frequency hops.

At 524, the gNB 304 may check the currently allocated SRS sequences to the RedCap UEs in multiple cells for positioning. In this example, at 526, the gNB 304 may decide not to accept the request from the RedCap UE 302. Then, at 528, the gNB 304 may transmit a rejection message about the request and indicate the RedCap UE 302 to report information on frequency hop(s) affected by the PAPR problem. At 530, the RedCap UE 302 may transmit an SRS on the SRS frequency hops using the configured SRS sequence and transmit information on the SRS frequency hop affected by the PAPR problem to the gNB 304. At 532, the RedCap UE 302 may transmit the SRS on the SRS frequency hops using the configured sequence.

Thus, in this example, the RedCap UE 302 may transmit a requesting message to the gNB 304, but the gNB 304 may not accept the request from the RedCap UE 302. The RedCap UE 302 is indicated to report information on the SRS frequency hop affected by high PAPR problem. In an example, the UE may report SRS frequency hop ID(s).

### Example Methods

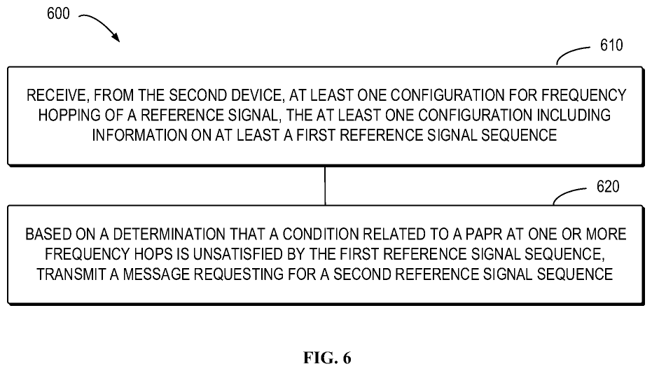

FIG. 6 shows a flowchart of an example method 600 implemented at a first device in accordance with some example embodiments of the present disclosure. The method 600 can be implemented by the first device 110 as shown in FIG. 1A. For the purpose of discussion, the method 600 will be described from the perspective of the first device 110 with reference to FIG. 1A.

At block 610, the first device 110 receives, from a second device, at least one configuration for frequency hopping of a reference signal. The at least one configuration including information on at least a first reference signal sequence. At block 620, based on a determination that a condition related to a PAPR at one or more frequency hops is unsatisfied by the first reference signal sequence, the first device 110 transmits a message requesting for a second reference signal sequence.

In some example embodiments, based on the configuration for frequency hopping of the reference signal, the first device 110 may determine a set of reference signal sequences satisfying the condition. In these embodiments, the message may include the determined set of reference signal sequences to request a reference signal sequence of the set of reference signal sequences as the second reference signal sequence.

In some example embodiments, the first device 110 may determine whether the PAPR associated with the first reference signal sequence is greater than a threshold PAPR at the one or more frequency hops. Based on a determination that the PAPR is greater than the threshold PAPR at the one or more frequency hops, the first device 110 may determine that the condition is unsatisfied.

In some example embodiments, the first device 110 may determine at least one threshold PAPR based on at least one of the following: a power amplifier capability including a dynamic range of the first device or at least one allowable signal distortion level of at least one receiver of the reference signal.

In some example embodiments, the first device 110 may receive, from the second device 120, the at least one allowable signal distortion level.

In some example embodiments, the at least one allowable signal distortion level may be indicated per receiver.

In some example embodiments, the at least one allowable signal distortion level and the at least one configuration for the frequency hopping may be received in one signaling message.

In some example embodiments, the message may further include the determined threshold PAPR.

In some example embodiments, the message may include a first request of a configuration for at least the second reference signal sequence satisfying the condition.

In some example embodiments, the first device 110 may receive, from the second device 120, a configuration for the second reference signal sequence. Then, the first device 110 may generate a reference signal based on the second reference signal sequence and transmit the generated reference signal.

In some example embodiments, the first device 110 may receive, from the second device 120, a notification of a rejection for the second reference signal sequence. In these example embodiments, the first device 110 may generate a reference signal based on the first reference signal sequence and transmit the generated reference signal.

In some example embodiments, the first device 110 may transmit, to the second device 120, information on at least one frequency hop affected from signal distortion associated with a PAPR. The PAPR associated with the first reference signal sequence may be greater than a threshold at the at least one affected frequency hop.

In some example embodiments, the information on the at least one frequency hop may comprise at least one identification of the at least one frequency hop.

In some example embodiments, the first device 110 may receive, from the second device 120, an indication to report information on a frequency hop of the at least one affected frequency hop.

In some example embodiments, based on a determination that the condition is unsatisfied, the first device 110 may transmit a second request related to at least one of: a bandwidth or the number of resource blocks of at least one frequency hop, or the number of overlapping resource blocks between frequency hops.

In some example embodiments, the reference signal may be used for positioning of the first device.

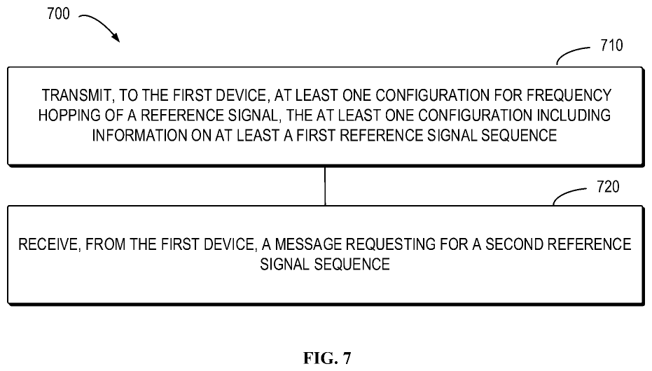

FIG. 7 shows a flowchart of an example method 700 implemented at a second device in accordance with some example embodiments of the present disclosure. The method 700 can be implemented by the second device 120 as shown in FIG. 1A. For the purpose of discussion, the method 700 will be described from the perspective of the second device 120 with reference to FIG. 1A.

At block 710, the second device 120 transmits, to the first device 110, at least one configuration for frequency hopping of a reference signal, the at least one configuration including information on at least a first reference signal sequence. At block 720, the second device 120 receives, from the first device 110, a message requesting for a second reference signal sequence.

In some example embodiments, the message may include at least one of: a threshold PAPR for one or more of frequency hops of the reference signal, a first request of a configuration for at least one further reference signal sequence providing a PAPR lower than the threshold PAPR, or a set of reference signal sequences providing a set of PAPRs lower than the threshold PAPR.

In some example embodiments, the second device 120 may transmit a configuration for the second reference signal sequence.

In some example embodiments, the second reference signal sequence may be determined from the set of reference signal sequences.

In some example embodiments, the second reference signal sequence may be determined based on a determination that the PAPR associated with the second reference signal sequence is equal to or less than the threshold PAPR at a predetermined number of frequency hops.

In some example embodiments, the second device 120 may transmit, to the third device 130, the at least one of the first request or the set of reference signal sequences. The second device 120 may receive, from the third device 130, a further set of refence signal sequences. In this case, the second reference signal sequence may be determined from the further set of refence signal sequences.

In some example embodiments, the second device 120 may transmit, to the first device 110, a notification of a rejection for the second reference signal sequence.

In some example embodiments, the second device 120 may receive, from the first device 110, information on at least one frequency hop affected from signal distortion associated with a PAPR. A PAPR associated with the first reference signal sequence may be greater than the threshold PAPR at the at least one affected frequency hop.

In some example embodiments, the information on the at least one frequency hop may comprise at least one identification of the at least one frequency hop.

In some example embodiments, the second device 120 may transmit, to the first device 110, an indication to report information on a frequency hop of the at least one affected frequency hop.

In some example embodiments, the second device 120 may transmit, to the first device 110, at least one allowable signal distortion level of at least one receiver of the reference signal.

In some example embodiments, the second device 120 may determine the at least one allowable signal distortion level based on at least one of: a received signal strength of the at least one receiver, a distance between the first device and the at least one receiver, or required measurement accuracy of the at least one receiver.

In some example embodiments, the at least one allowable signal distortion level may be indicated to the first device per receiver.

In some example embodiments, the at least one signal distortion allowable level and the at least one configuration for the frequency hopping may be transmitted in one signaling message.

In some example embodiments, the second device 120 may receive, from the first device 110, a second request related to at least one of a bandwidth or the number of resource blocks of at least one frequency hop, or the number of overlapping resource blocks between frequency hops.

In some example embodiments, the second device 120 may transmit, to the third device 130, the at least one configuration for the frequency hopping of the reference signal.

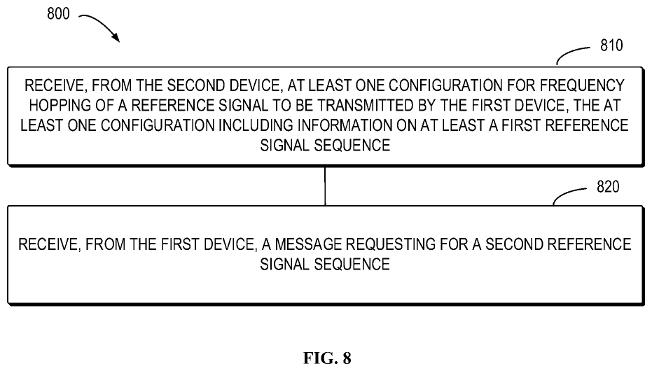

FIG. 8 shows a flowchart of an example method 800 implemented at a third device in accordance with some example embodiments of the present disclosure. The method 800 can be implemented by the third device 130 as shown in FIG. 1A. For the purpose of discussion, the method 800 will be described from the perspective of the third device 130 with reference to FIG. 1A.

At block 810, the third device 130 receives, from the second device 120, at least one configuration for frequency hopping of a reference signal to be transmitted by a first device, the at least one configuration including information on at least a first reference signal sequence. At block 820, the third device 130 receives, from the first device 110, a message requesting for a second reference signal sequence.

In some example embodiments, the message may include at least one of a threshold PAPR, a first request of a configuration for at least one further reference signal sequence providing a PAPR lower than the threshold PAPR, or a set of reference signal sequences providing a set of PAPRs lower than the threshold PAPR.

In some example embodiments, the method 800 further comprises: transmitting, to the second device, a further set of refence signal sequences for use by the first device.

In some example embodiments, in response to receiving the set of reference signal sequences from the first device, the third device 130 may determine the further set of refence signal sequences from the received set of refence signal sequences.

In some example embodiments, the further set of refence signal sequences may be determined based on a determination that a set of PAPRs associated with the second set of refence signal sequences is equal to or less than the threshold PAPR at a predetermined number of frequency hops.

All operations and features related to the first device 110, the second device 120 and the third device 130 as described above with reference to FIGS. 1A to 5 are likewise applicable to the methods 600, 700 and 800 and have similar effects. For the purpose of simplification, the details will be omitted.

### Example Apparatus, Device and Medium

In some example embodiments, a first apparatus capable of performing the method 600 (for example, the first device 110 in FIG. 1A) may comprise means for performing the respective operations of the method 600. The means may be implemented in any suitable form. For example, the means may be implemented in a circuitry or software module. The first apparatus may be implemented as or included in the first device 110 in FIG. 1A.

In some example embodiments, the first apparatus comprises means for receiving, from a second device, at least one configuration for frequency hopping of a reference signal, the at least one configuration including information on at least a first reference signal sequence; and means for based on a determination that a condition related to a PAPR at one or more frequency hops is unsatisfied by the first reference signal sequence, transmitting a message requesting for a second reference signal sequence.

In some example embodiments, the first apparatus further comprises means for determining, based on the configuration for frequency hopping of the reference signal, a set of reference signal sequences satisfying the condition, wherein the message includes the determined set of reference signal sequences to request a reference signal sequence of the set of reference signal sequences as the second reference signal sequence.

In some example embodiments, the first apparatus further comprises: means for determining whether the PAPR associated with the first reference signal sequence is greater than a threshold PAPR at the one or more frequency hops; and means for based on a determination that the PAPR is greater than the threshold PAPR at the one or more frequency hops, determining that the condition is unsatisfied.

In some example embodiments, the first apparatus further comprises: means for determining at least one threshold PAPR based on at least one of the following: a power amplifier capability including a dynamic range of the first device or at least one allowable signal distortion level of at least one receiver of the reference signal.

In some example embodiments, the first apparatus further comprises: means for receiving, from the second device, the at least one allowable signal distortion level.

In some example embodiments, the at least one allowable signal distortion level is indicated per receiver.

In some example embodiments, the at least one allowable signal distortion level and the at least one configuration for the frequency hopping is received in one signaling message.

In some example embodiments, the message further includes the determined threshold PAPR.

In some example embodiments, the message includes a first request of a configuration for at least the second reference signal sequence satisfying the condition.

In some example embodiments, the first apparatus further comprises: means for receiving, from the second device, a configuration for the second reference signal sequence; means for generating a reference signal based on the second reference signal sequence; and means for transmitting the generated reference signal.

In some example embodiments, the first apparatus further comprises: means for receiving, from the second device, a notification of a rejection for the second reference signal sequence; means for generating a reference signal based on the first reference signal sequence; and means for transmitting the generated reference signal.

In some example embodiments, the first apparatus further comprises: means for transmitting, to the second device, information on at least one frequency hop affected from signal distortion associated with a PAPR, wherein the PAPR associated with the first reference signal sequence is greater than a threshold at the at least one affected frequency hop.

In some example embodiments, the information on the at least one frequency hop comprises at least one identification of the at least one frequency hop.

In some example embodiments, the first apparatus further comprises: means for receiving, from the second device, an indication to report information on a frequency hop of the at least one affected frequency hop.

In some example embodiments, the first apparatus further comprises: means for based on a determination that the condition is unsatisfied, transmitting a second request related to at least one of: a bandwidth or the number of resource blocks of at least one frequency hop, or the number of overlapping resource blocks between frequency hops.

In some example embodiments, the reference signal is used for positioning of the first device.

In some example embodiments, the first device comprises a terminal device, and the second device comprises a network device.

In some example embodiments, the first apparatus further comprises means for performing other operations in some example embodiments of the method 600 or the first device 110. In some example embodiments, the means comprises at least one processor; and at least one memory storing instructions that, when executed by the at least one processor, cause the performance of the first apparatus.

In some example embodiments, a second apparatus capable of performing the method 700 (for example, the second device 120 in FIG. 1A) may comprise means for performing the respective operations of the method 700. The means may be implemented in any suitable form. For example, the means may be implemented in a circuitry or software module. The second apparatus may be implemented as or included in the second device 120 in FIG. 1A.

In some example embodiments, the second apparatus comprises means for transmitting, to a first device, at least one configuration for frequency hopping of a reference signal, the at least one configuration including information on at least a first reference signal sequence; and means for receiving, from the first device, a message requesting for a second reference signal sequence.

In some example embodiments, the message includes at least one of: a threshold PAPR for one or more of frequency hops of the reference signal, a first request of a configuration for at least one further reference signal sequence providing a PAPR lower than the threshold PAPR, or a set of reference signal sequences providing a set of PAPRs lower than the threshold PAPR.

In some example embodiments, the second apparatus further comprises: means for transmitting a configuration for the second reference signal sequence.

In some example embodiments, the second reference signal sequence is determined from the set of reference signal sequences.

In some example embodiments, the second reference signal sequence is determined based on a determination that the PAPR associated with the second reference signal sequence is equal to or less than the threshold PAPR at a predetermined number of frequency hops.

In some example embodiments, the second apparatus further comprises: means for transmitting, to a third device, the at least one of the first request or the set of reference signal sequences; and means for receiving, from the third device, a further set of refence signal sequences, wherein the second reference signal sequence is determined from the further set of refence signal sequences.

In some example embodiments, the second apparatus further comprises: means for transmitting, to the first device, a notification of a rejection for the second reference signal sequence.

In some example embodiments, the second apparatus further comprises: means for receiving, from the first device, information on at least one frequency hop affected from signal distortion associated with a PAPR, wherein a PAPR associated with the first reference signal sequence is greater than the threshold PAPR at the at least one affected frequency hop.

In some example embodiments, the information on the at least one frequency hop comprises at least one identification of the at least one frequency hop.

In some example embodiments, the second apparatus further comprises: means for transmitting, to the first device, an indication to report information on a frequency hop of the at least one affected frequency hop.

In some example embodiments, the second apparatus further comprises: means for transmitting, to the first device, at least one allowable signal distortion level of at least one receiver of the reference signal.

In some example embodiments, the second apparatus further comprises: means for determining the at least one allowable signal distortion level based on at least one of: a received signal strength of the at least one receiver, a distance between the first device and the at least one receiver, or required measurement accuracy of the at least one receiver.

In some example embodiments, the at least one allowable signal distortion level is indicated to the first device per receiver.

In some example embodiments, the at least one signal distortion allowable level and the at least one configuration for the frequency hopping is transmitted in one signaling message.

In some example embodiments, the second apparatus further comprises: means for receiving, from the first device, a second request related to at least one of a bandwidth or the number of resource blocks of at least one frequency hop, or the number of overlapping resource blocks between frequency hops.

In some example embodiments, the reference signal is used for positioning of the first device.

In some example embodiments, the second apparatus further comprises: means for transmitting, to a third device, the at least one configuration for the frequency hopping of the reference signal.

In some example embodiments, the first device comprises a terminal device, the second device comprises a network device, and the third device comprises a location management function.

In some example embodiments, the second apparatus further comprises means for performing other operations in some example embodiments of the method 700 or the second device 120. In some example embodiments, the means comprises at least one processor; and at least one memory storing instructions that, when executed by the at least one processor, cause the performance of the second apparatus.

In some example embodiments, a third apparatus capable of performing the method 800 (for example, the third device 130 in FIG. 1A) may comprise means for performing the respective operations of the method 800. The means may be implemented in any suitable form. For example, the means may be implemented in a circuitry or software module. The third apparatus may be implemented as or included in the third device 130 in FIG. 1A.

In some example embodiments, the third apparatus comprises means for receiving, from a second device, at least one configuration for frequency hopping of a reference signal to be transmitted by a first device, the at least one configuration including information on at least a first reference signal sequence; and means for receiving, from the first device, a message requesting for a second reference signal sequence.

In some example embodiments, the message includes at least one of a threshold PAPR, a first request of a configuration for at least one further reference signal sequence providing a PAPR lower than the threshold PAPR, or a set of reference signal sequences providing a set of PAPRs lower than the threshold PAPR.

In some example embodiments, the third apparatus further comprises: means for transmitting, to the second device, a further set of refence signal sequences for use by the first device.

In some example embodiments, the third apparatus further comprises: means for in response to receiving the set of reference signal sequences from the first device, determining the further set of refence signal sequences from the received set of refence signal sequences.

In some example embodiments, the further set of refence signal sequences is determined based on a determination that a set of PAPRs associated with the second set of refence signal sequences is equal to or less than the threshold PAPR at a predetermined number of frequency hops.

In some example embodiments, the reference signal is used for positioning of the first device.

In some example embodiments, the first device comprises a terminal device, the second device comprises a network device, and the third device comprises a location management function.

In some example embodiments, the third apparatus further comprises means for performing other operations in some example embodiments of the method 800 or the third device 130. In some example embodiments, the means comprises at least one processor; and at least one memory storing instructions that, when executed by the at least one processor, cause the performance of the third apparatus.

FIG. 9 is a simplified block diagram of a device 900 that is suitable for implementing example embodiments of the present disclosure. The device 900 may be provided to implement a communication device, for example, the first device 110, the second device 120 or the third device 130 as shown in FIG. 1A. As shown, the device 900 includes one or more processors 910, one or more memories 920 coupled to the processor 910, and one or more communication modules 940 coupled to the processor 910.

The communication module 940 is for bidirectional communications. The communication module 940 has one or more communication interfaces to facilitate communication with one or more other modules or devices. The communication interfaces may represent any interface that is necessary for communication with other network elements. In some example embodiments, the communication module 940 may include at least one antenna.

The processor 910 may be of any type suitable to the local technical network and may include one or more of the following: general purpose computers, special purpose computers, microprocessors, digital signal processors (DSPs) and processors based on multicore processor architecture, as non-limiting examples. The device 900 may have multiple processors, such as an application specific integrated circuit chip that is slaved in time to a clock which synchronizes the main processor.

The memory 920 may include one or more non-volatile memories and one or more volatile memories. Examples of the non-volatile memories include, but are not limited to, a Read Only Memory (ROM) 924, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 922 and other volatile memories that will not last in the power-down duration.

A computer program 930 includes computer executable instructions that are executed by the associated processor 910. The instructions of the program 930 may include instructions for performing operations/acts of some example embodiments of the present disclosure. The program 930 may be stored in the memory, e.g., the ROM 924. The processor 910 may perform any suitable actions and processing by loading the program 930 into the RAM 922.

The example embodiments of the present disclosure may be implemented by means of the program 930 so that the device 900 may perform any process of the disclosure as discussed with reference to FIG. 1A to FIG. 8. The example embodiments of the present disclosure may also be implemented by hardware or by a combination of software and hardware.

In some example embodiments, the program 930 may be tangibly contained in a computer readable medium which may be included in the device 900 (such as in the memory 920) or other storage devices that are accessible by the device 900. The device 900 may load the program 930 from the computer readable medium to the RAM 922 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

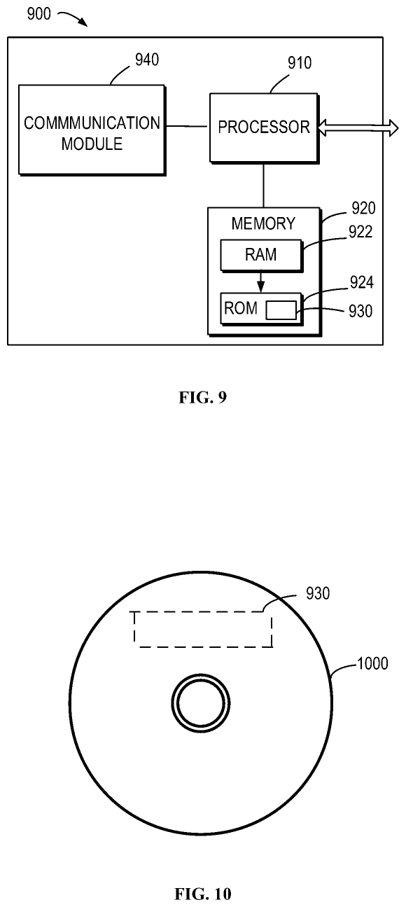

FIG. 10 shows an example of the computer readable medium 1000 which may be in form of CD, DVD or other optical storage disk. The computer readable medium 1000 has the program 930 stored thereon.

Generally, various embodiments of the present disclosure may be implemented in hardware or special purpose circuits, software, logic or any combination thereof. Some aspects may be implemented in hardware, and other aspects may be implemented in firmware or software which may be executed by a controller, microprocessor or other computing device. Although various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, although operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, although several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A first device comprising:
at least one processor; and
at least one memory storing instructions that, when executed by the at least one processor, cause the first device at least to perform:
receiving, from a second device, at least one configuration for frequency hopping of a reference signal, the at least one configuration including information on at least a first reference signal sequence; and
based on a determination that a condition related to a peak to average power ratio (PAPR) at one or more frequency hops is unsatisfied by the first reference signal sequence, transmitting a message requesting for a second reference signal sequence.

2. The first device of claim 1, further caused at least to perform:
determining, based on the configuration for frequency hopping of the reference signal, a set of reference signal sequences satisfying the condition,
wherein the message includes the determined set of reference signal sequences to request a reference signal sequence of the set of reference signal sequences as the second reference signal sequence.

3. The first device of claim 1, further caused at least to perform:
determining whether the PAPR associated with the first reference signal sequence is greater than a threshold PAPR at the one or more frequency hops; and
based on a determination that the PAPR is greater than the threshold PAPR at the one or more frequency hops, determining that the condition is unsatisfied.

4. The first device of claim 3, further caused at least to perform:
determining at least one threshold PAPR based on at least one of the following: a power amplifier capability including a dynamic range of the first device or at least one allowable signal distortion level of at least one receiver of the reference signal.

5. The first device of claim 4, further caused at least to perform:
receiving, from the second device, the at least one allowable signal distortion level.

6. The first device of claim 5, wherein the at least one allowable signal distortion level is indicated per receiver.

7. The first device of claim 5, wherein the at least one allowable signal distortion level and the at least one configuration for the frequency hopping is received in one signaling message.

8. The first device of claim 4, wherein the message further includes the determined threshold PAPR.

9. The first device of claim 1, wherein the message includes a first request of a configuration for at least the second reference signal sequence satisfying the condition.

10. The first device of claim 9, further caused at least to perform:
receiving, from the second device, a configuration for the second reference signal sequence;
generating a reference signal based on the second reference signal sequence; and
transmitting the generated reference signal.

11. The first device of claim 9, further caused at least to perform:
receiving, from the second device, a notification of a rejection for the second reference signal sequence;
generating a reference signal based on the first reference signal sequence; and
transmitting the generated reference signal.

12. The first device of claim 11, further caused at least to perform:
transmitting, to the second device, information on at least one frequency hop affected from signal distortion associated with a PAPR, wherein the PAPR associated with the first reference signal sequence is greater than a threshold at the at least one affected frequency hop.

13. The first device of claim 12, wherein the information on the at least one frequency hop comprises at least one identification of the at least one frequency hop.

14. The first device of claim 12, further comprising:
receiving, from the second device, an indication to report information on a frequency hop of the at least one affected frequency hop.

15. The first device of claim 1, further comprising:
based on a determination that the condition is unsatisfied, transmitting a second request related to at least one of:
a bandwidth or the number of resource blocks of at least one frequency hop, or
the number of overlapping resource blocks between frequency hops.

16. The first device of claim 1, wherein the reference signal is used for positioning of the first device.

17. The first device of claim 1, wherein the first device comprises a terminal device, and the second device comprises a network device.

18. A method second device comprising:
at least one processor; and
at least one memory storing instructions that, when executed by the at least one processor, cause the first device at least to perform:
transmitting, to a first device, at least one configuration for frequency hopping of a reference signal, the at least one configuration including information on at least a first reference signal sequence; and
receiving, from the first device, a message requesting for a second reference signal sequence.

19-35. (canceled)

36. A third device comprising:
at least one processor; and
at least one memory storing instructions that, when executed by the at least one processor, cause the first device at least to perform:
receiving, from a second device, at least one configuration for frequency hopping of a reference signal to be transmitted by a first device, the at least one configuration including information on at least a first reference signal sequence; and
receiving, from the first device, a message requesting for a second reference signal sequence.

37-41. (canceled)

42. The third device of claim 36, wherein the first device comprises a terminal device, the second device comprises a network device, and the third device comprises a location management function.

43-45. (canceled)
